(19) United States
(12) Patent Application Publication
(10) Pub. No.: US 2011/0287153 A1
(43) Pub. Date: Nov. 24, 2011

(54) Hot press for creating an ornamental design in already cooked food products

(76) Inventor: Michael Zimmer, Fleming Islands, FL (US)

(21) Appl. No.: 13/068,785

(22) Filed: May 20, 2011

Related U.S. Application Data
(60) Provisional application No. 61/396,254, filed on May 24, 2010.

(51) Int. Cl. A23P 1/00; A21D 13/00

(52) U.S. Cl. 426/383

(57) ABSTRACT

The present invention comprises a device, apparatus, system and method and combinations thereof that provides a plate with an ornamental design such as but not limited to grooves such as found on grilled food articles in “panini” style sandwiches that attaches to a hot press machine wherein already cooked food articles, such as bread, are placed into the heated press, compressed, and removed from the press after an ornamental design has been applied to the food article.

### CROSS-REFERENCE TO RELATED APPLICATIONS

Priority is claimed from provisional patent application U.S. Ser. No. 61/396,254 filed on May 24, 2010 and incorporated by reference herein.

### BACKGROUND OF THE INVENTION

1. Field of the Invention

In general, the present invention relates to an apparatus for compressing already cooked food articles into a particular ornamental design. More in particular, the present invention generally provides an apparatus and method for taking an already cooked food article, such as but not limited to a piece of bread, and applying a grooved design to make the already cooked item appeared to be grilled “panini” style. It is understood that numerous food products are contemplated and other ornamental designs and shapes.

2. Description of the Prior Art

Panini sandwiches have become very popular over the years. The term “panini” is most commonly associated with grilled sandwiches wherein a grill device is compressed cooking the sandwich and typically creating grill marks in the bread. Of note, the literal translation of the word “panini” is bread in Italian, although the term has come to be more commonly known as a type of sandwich that is grilled comprising two loaves or slices of bread compressed on a grill that creates crunchy bread packed with warm meats and melted cheeses.

Traditionally, Italians would use a pan weighted with soup cans to compress the sandwich. Today, panini grills and panini presses are common. The press down motion typically sets the panini sandwich apart from other sandwiches. The pressure applied not only crisps the panini sandwich bread, but also typically cooks the ingredients between.

It is also common now to find the term “panini” generically applied to other foods that are produced by the compression grilling method or generally have grill marks with ridges and furrows from the compression process. The term “panini” has also come to symbolize freshly cooked and tasty bread products that have been compressed grill cooked.

In already prepared food items, such as bread product like loaves of bread or buns that are made in mass and sold in bulk quantities, it is also desirable to have an ornamental design that makes the product looked grilled although the grilling process is not needed to fully cook the item nor generally utilized in the cooking process. It is generally desirable to have an ornamental design on the finished food product that conjures up the thought of “panini” style grilling although the “panini” process is not truly employed in the product.

Furthermore, most fast food restaurants do not have the time to produce a “panini” style sandwich or doing so would be cost prohibitive. This is also true with pre-made bread products such as already made sandwiches found in vending machines, convenience stores, retail grocery stores, and so forth. This is still further true with other types of pre-made and packaged food items where it is desirable to have a freshly grilled appearance as found in “panini” styled grilling.

In view of the above, there is currently a need for a device that provides an ornamental “panini” design on already fully cooked food articles. Currently in the prior art, there is no device or system which is sufficient. The above discussion is not to be considered exhaustive, however, does demonstrate that a need exists for a hot press that provides a grilled appearance to already cooked food articles. The consuming industry is looking for solutions, methods, and systems to address these needs and there is an obvious need to fill the gap where the prior art has failed. What is needed is an apparatus, system and method to address these shortcomings in the prior art while also addressing the significance of the issues presented.

### SUMMARY OF THE INVENTION

In view of the foregoing disadvantages inherent in the known types of methods and apparatus associated with preparing food articles now present in the prior art, the current invention provides a new and improved apparatus, system and method of using the same where the prior art fails. As such, the general purpose of the present invention, which will be described subsequently in greater detail, is to provide a new and improved hot press for applying a grooved grill design to already cooked food articles such as but not limited to buns, which has all the advantages of the prior art and none of the disadvantages.

The present invention essentially provides a plate with an ornamental design such as but not limited to grooves such as found on grilled food articles in panini style sandwiches that attaches to a hot press machine. Already cooked food articles, such as bread, are placed into the heated press, compressed, and removed from the press after an ornamental design has been applied to the food article.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction, arrangement of the components, systems, ranges and amounts thereof set forth in the following description. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other apparatus, compositions, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Therefore, it is an object of the present invention to provide a new and improved hot press device, assembly, apparatus, system, and method that may be easily and effectively utilized to provide an ornamental grill design to already cooked food articles.

It is a further object of the present invention to provide a new and improved hot press device, assembly, apparatus, system, and method that provides a panini style grill mark with physical grooves in the food article as desired.

An even further object of the present invention is to provide a new and improved hot press device, assembly, apparatus, system, and method that is susceptible to a low cost of manufacture and implementation, and, thus accordingly, is then susceptible to low prices of sale or use to the consuming industry thereby making such economically available.

Still another object of the present invention is to provide a new and improved hot press device, assembly, apparatus, system, and method which provides all of the advantages of the prior art, while simultaneously overcoming some of the disadvantages normally associated therewith.

Another object of the present invention is to provide a new and improved hot press device, assembly, apparatus, system, and method that may provide for mass production wherein numerous food articles may be processed.

Yet another object of the present invention is to provide a new and improved hot press device, assembly, apparatus, system, and method that allows for utilization with existing press equipment found in the art and or retrofitted to the same.

An even further object of the present invention is to provide a new and improved hot press device, assembly, apparatus, system, and method that may be utilized in relatively short pressing cycles to further speed the end resulting product.

Still another object of the present invention is to provide a new and improved hot press device, assembly, apparatus, system, and method that provides an aesthetically pleasing food article.

Another object of the present invention is to provide a new and improved hot press device assembly, apparatus, system, and method that may be generally utilized in a conveyor belt assembly process for food articles as desired.

These, together with other objects of the invention, along with the various features of novelty that characterize the invention, are pointed out with particularity in the claims annexed to and forming a part of this disclosure. For a better understanding of the invention, its operating advantages, and the specific objects attained by its uses, reference should be had to the accompanying descriptive matter in which there are illustrated preferred embodiments of the invention.

### BRIEF DESCRIPTION OF THE PICTORIAL ILLUSTRATIONS GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, and appendices.

FIG. 1 is generally a top view picture of a finished imprinted piece of already fully cooked bread on top of a sandwich in accordance with a preferred embodiment of the invention.

FIG. 2 is generally a perspective view picture of the imprinted piece of already cooked bread as shown generally in FIG. 1 in accordance with a preferred embodiment of the invention.

FIG. 3A is generally a top view illustration of a press plate in accordance with a preferred embodiment of the invention.

FIG. 3B is generally a perspective view illustration of the press plate generally shown in FIG. 3A in accordance with a preferred embodiment of the invention.

FIG. 3C is generally a side view illustration of the press plate generally shown in FIG. 3A in accordance with a preferred embodiment of the invention.

FIG. 4 is generally a top view picture of a finished imprinted piece of already fully cooked bread on top of a sandwich in accordance with a preferred embodiment of the invention.

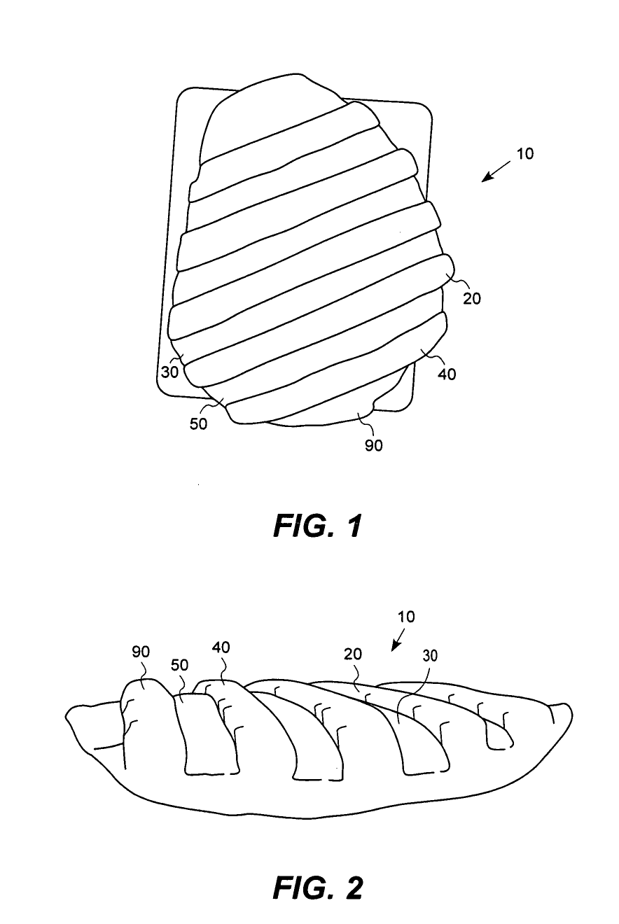

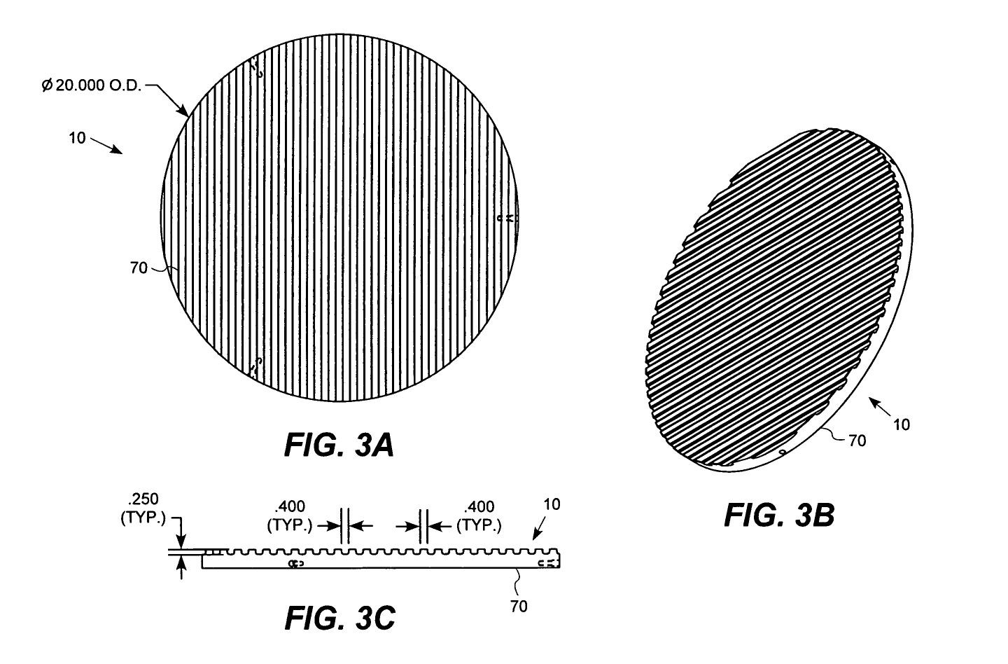

### DETAILED DESCRIPTION

Referring to the illustrations, pictures and drawings, in a preferred embodiment, invention 10 generally comprises a device, apparatus, system, method and combinations thereof for applying an ornamental design 20 into an already fully cooked food article 30 such as but not limited to bread used for buns, sandwiches, and so forth. Design 20 is generally a “panini” type look of grill markings having ridges 40 and furrows 50. It is understood that although the illustrations and detailed description refer to the invention generally as a “hot press”, the current invention should not be limited by the term. Furthermore, the term “panini” is used for illustrative purposes and should not be considered to limit the invention as such. It is contemplated that the current invention may have numerous applications and utilities where it is desired to generally provide an ornamental design to an already or fully cooked food article.

It is understood that hot presses are known in the prior art and that “panini” grills also are known in the prior art. Invention 10 is directed to produce grooved design 20 to make fully cooked food article 30, such as a slice of fully cooked bread product look like a grilled “panini” piece of bread and not specifically for cooking the food article as done traditionally in a “panini” grill or grill in general.

Hot press 60 (not depicted) may be generally of the type of design traditionally found to be used for flattening or shaping raw dough balls and pressing out to a tortilla, pizza, etc. It is contemplated to use hot press 60 such as used for pressing pizza dough into pizza crusts such as but not limited to the AM MANUFACTURING LT 1800BH LITTLE TORO although it is understood that other types of hot press devices may be utilized. It is further understood that much larger hot press 60 machines may be utilized for continuous operation on a conveyor belt system and the following illustrations are not to be considered the invention to such only.

In a preferred embodiment, hot press 60 is fitted with a die 70 having ridges 40 and furrows 50. It is understood that die 70 may engage a generally flat surface 80 (not depicted), but it is further contemplated that another die 70 with an ornamental design 20 may also be utilized such that both sides of the food article 30 are imprinted. It is also understood that die 70 may interact with a different design for creating two different ornamental designs 20 on food article or product 30.

In a preferred embodiment, food article 30 or more than one food article 30 is generally placed in hot press 60 between die 70 and flat surface 80 such that compression is achieved. It is understood that depending on the size of food article 30 and the desired design 20, numerous changes may be contemplated regarding compression. It is generally contemplated that sufficient compression must be achieved for creating ridges 40 and furrows 50.

It is also understood that die 70 shape may be other than circular. Die 70 may be square, oblong, rectangular, combinations thereof and so forth. It is understood that the illustrations should not be considered to limit the invention to such.

It is further contemplated invention 10 may be utilized on such food items as doughnuts, pastries, snack foods, and so forth where it is desirable to create grill marks to already generally cooked, fully cooked, processed, and or combinations thereof food items. It is also contemplated to generally create a blackening or browning ornamental design that may generally have the appearance of lines 90 with or without ridges 40 and furrows 50.

### In Operation

It is contemplated to generally heat hot press 60 die 70 to about 450-Fahrenheit degrees, compressing food article 30 by depressing die 70 toward surface 80 for approximately 5 to 10 seconds, lifting die 70, and then removing food article 30 that now has ridges 40, furrows 50 and or lines 90. It is understood that temperature may be more than or less than 450-Fahrenheit degrees and will vary according to the food article 30, desired depth of compression, desired end ornamental design 20 and so forth. Other preferred embodiment may utilize between 400-Fahrenheit degrees and 525-Fahrenheit degrees.

It is also understood that time may be greater or less depending once again on the food article 30, desired depth of compression, desired end ornamental design 20 and so forth. It is contemplated that higher temperatures may require less compression time. It is also contemplated that lower temperatures may require longer compression time. It is still also contemplated to provide sufficient heat to brand or grill into the food article 30 a look that is colored brownish, black, and combinations thereof. It is still further contemplated to provide a food color additive to the die 70 to create a brown or black appearance of the ornamental design 20.

It is further contemplated that both sides of food article 30 may be imprinted. In a preferred operation, this can be done on an automated basis by having two hot press machines 60 machines back up to each other and flipping the food article 30 bread or bun between the hot press machines 60. One hot press machine 60 may make a first impression on one side of food article 30, flipping the food article 30, and then imprinting the food article 30 second side with another hot press machine 60.

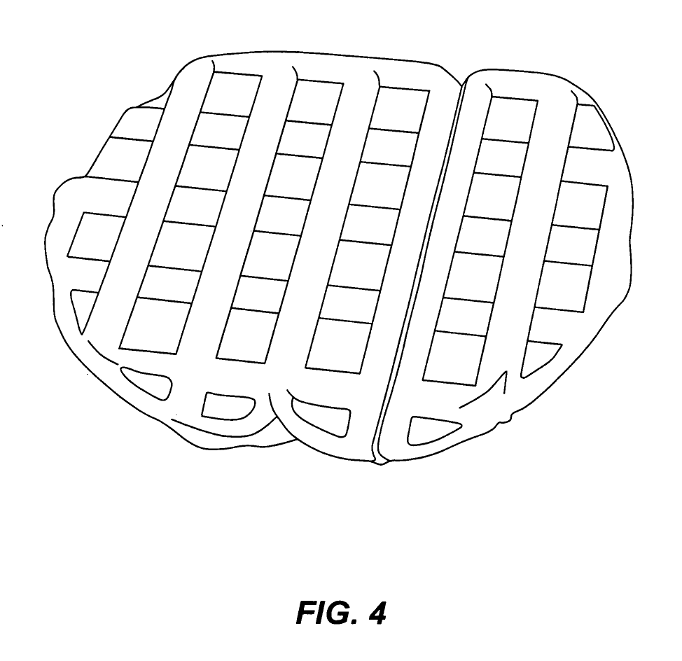

Referring once again to the illustrations and more particularly to FIG. 4, it is also contemplated, to produce a “waffle” pattern 100. In a preferred operation, this can be done on an automated basis by having two hot press machines 60 machines back up to each other and rotating the food article 30 ninety degrees before passing through second hot press machine 60. It is also contemplated to not rotate the food article 30, but rather rotate one of hot press machine 60 die 70 ninety degrees before administering the second imprint on food article 30. It is understood that the pattern may be more than or less than ninety degrees and the illustrations should not be considered to limit the invention to such. It is contemplated to have different angles of imprints. It is still further contemplated that die 70 may have “waffle” pattern 100 which would only require one imprinting on food article 30.

A number of implementations have been described herein. Nevertheless, it will be understood that various modifications may be made. Accordingly, other implementations are within the scope of the following claims. Changes may be made in the combinations, operations, and arrangements of the various parts, elements, and amounts described herein without departing from the spirit and scope of the invention. From the foregoing description of the preferred embodiment of the invention, it will be apparent that many modifications can be made, and it will be understood that the presently disclosed embodiment is exemplary only, and that the invention is not limited thereto

I claim:

1. A method for creating an ornamental design in an already cooked food product comprising:
providing said already cooked food product;
providing a hot press having a die with an ornamental design;
heating said die;
compressing said already cooked food product with said hot press die;
creating an ornamental design in said already cooked food product;
lifting said die from said already cooked food product; and
removing said cooked food product from said hot press.

2. The method of claim 1 wherein said already cooked food product is bread.

3. The method of claim 2 wherein the step of heating said die includes heating to between about 400 Fahrenheit degrees and about 525 Fahrenheit degrees.

4. The method of claim 3 wherein the step compressing said already cooked bread product is for approximately 5 to 10 seconds.

5. The method of claim 4 wherein said ornamental design on said die has alternating ridges and furrows and said step of creating an ornamental design in said already cooked food product includes creating ornamental design in said already cooked bread product with alternating ridges and furrows.

6. The method of claim 5 wherein said step of creating an creating an ornamental design in said already cooked bread product with alternating ridges and furrows further includes coloring said already cooked bread product with alternating ridges and furrows.

7. The method of claim 6 wherein said coloring is brown and or black.
